(19) United States
(12) Patent Application Publication
(10) Pub. No.: US 2013/0174877 A1
(43) Pub. Date: Jul. 11, 2013

(54) LOW SPEED DRAIN DELAY

(71) Applicant: John Gilman Chapman, Louisville, KY (US)

(72) Inventor: John Gilman Chapman, Louisville, KY (US)

(73) Assignee: GENERAL ELECTRIC COMPANY, Schenectady, NY (US)

(21) Appl. No.: 13/348,047

(22) Filed: Jan. 11, 2012

(51) Int. Cl. A47L 15/42; B08B 3/04

(52) U.S. Cl. 134/25.2; 134/104.1

(57) ABSTRACT

A method of soil discharge in a dishwashing appliance during a wash cycle to maximize cleaning performance and dishwasher efficiency is provided. A dishwasher may circulate water at varying speeds until soil settles within a sump before discharge from the dishwashing chamber.

### FIELD OF THE INVENTION

The subject matter of the present invention generally relates to soil discharge in a dishwasher during a wash cycle.

### BACKGROUND OF THE INVENTION

Conventional dishwashers typically include a wash chamber where e.g., detergent, water, and heat can be used to clean food or other materials from dishes and other articles being washed. Various cycles may be included as part of the overall cleaning process. For example, a typical, user-selected cleaning option may include a wash cycle, rinse cycle, a drying cycle, and a sanitize cycle. A pre-wash cycle may also be included as part of the normal cleaning cycle or as an option for particularly soiled dishes.

In one or more of these cycles, particularly during the pre-wash cycle and the wash cycle, soil may be removed from the dishes. It is desirable to remove the soil from the wash chamber in order to maximize cleaning performance and appliance efficiency. Conventional dishwashers have utilized various approaches in an attempt to achieve this result.

Generally, during a wash cycle, after water is circulated throughout the tub, a pump is energized a single time to remove soil from the washing chamber. The drawback of this method is that typically not all soil is removed. When the rinse cycle begins, clean water then mixes with the soil and residual dirty water remaining in the bottom of the tub and is recirculated throughout the tub. Soil reattaches to the dishes within the wash chamber and remains on the dishes throughout the entire operation.

Another approach conventional dishwasher utilize is to completely stop a single speed water recirculation motor for a period of time before draining the washing chamber of water and soil. This method also results in inefficient soil discharge and recirculates dirty water and soil during a rinse cycle.

Previous attempts have been made to prevent this problem. For example, performing soil discharge twice during a wash cycle. Water may be circulated through the wash chamber a first time and then the soil discharge pump would be energized to discharge soil. However, when the residual soil remains in the tub, the soil discharge pump is energized a second time after water is circulated a second time throughout the wash chamber. This approach is inefficient because it uses excess water and power to remove soil from the wash chamber.

Accordingly, a need exists for a wash cycle that maximizes cleaning performance and dishwasher efficiency. A soil discharge method in a dishwasher that circulates water at varying speeds until soil settles within a sump before discharge would also be beneficial.

### BRIEF DESCRIPTION OF THE INVENTION

Aspects and advantages of the invention will be set forth in part in the following description, or may be obvious from the description, or may be learned through practice of the invention.

In one exemplary embodiment, the present invention provides a dishwasher appliance that includes a tub that defines a chamber for receipt of articles for cleaning, a fluid circulation assembly that circulates water in the tub, a pump that removes soil from the tub and a controller in communication with the fluid circulation assembly and the sump pump. The controller operates the fluid circulation assembly at a first speed and a second speed during a wash cycle, where the second speed is slower than the first speed but greater than zero. Further, the controller activates the pump to remove soil from the tub after the fluid circulation assembly is driven at the second speed.

In another exemplary embodiment, the present invention provides a method for removing soil from within a dishwasher. The method includes the steps of driving a fluid circulation assembly at a first speed to circulate water in a tub of the dishwasher during a wash cycle, driving the fluid circulation assembly at a second speed during the wash cycle, where the second speed is slower than the first speed and greater than zero, and removing soil from the tub after driving the fluid circulation assembly at the second speed by activating a drain pump.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front, perspective view of an exemplary dishwashing appliance of the present invention.

FIG. 2 provides a side, cross-sectional view of the exemplary embodiment of FIG. 1.

FIG. 3 provides a flow chart of a method for removing soil from within a dishwasher according to an exemplary embodiment of the present disclosure.

FIG. 4 provides a flow chart of a method for removing soil from within a dishwasher according to an alternative exemplary embodiment of the present disclosure.

### DETAILED DESCRIPTION OF THE INVENTION

The present invention relates to a method of soil discharge in a dishwashing appliance during a wash cycle to maximize cleaning performance and dishwasher efficiency. A dishwasher may circulate water at varying speeds until soil settles within a sump before discharge from the dishwashing chamber.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

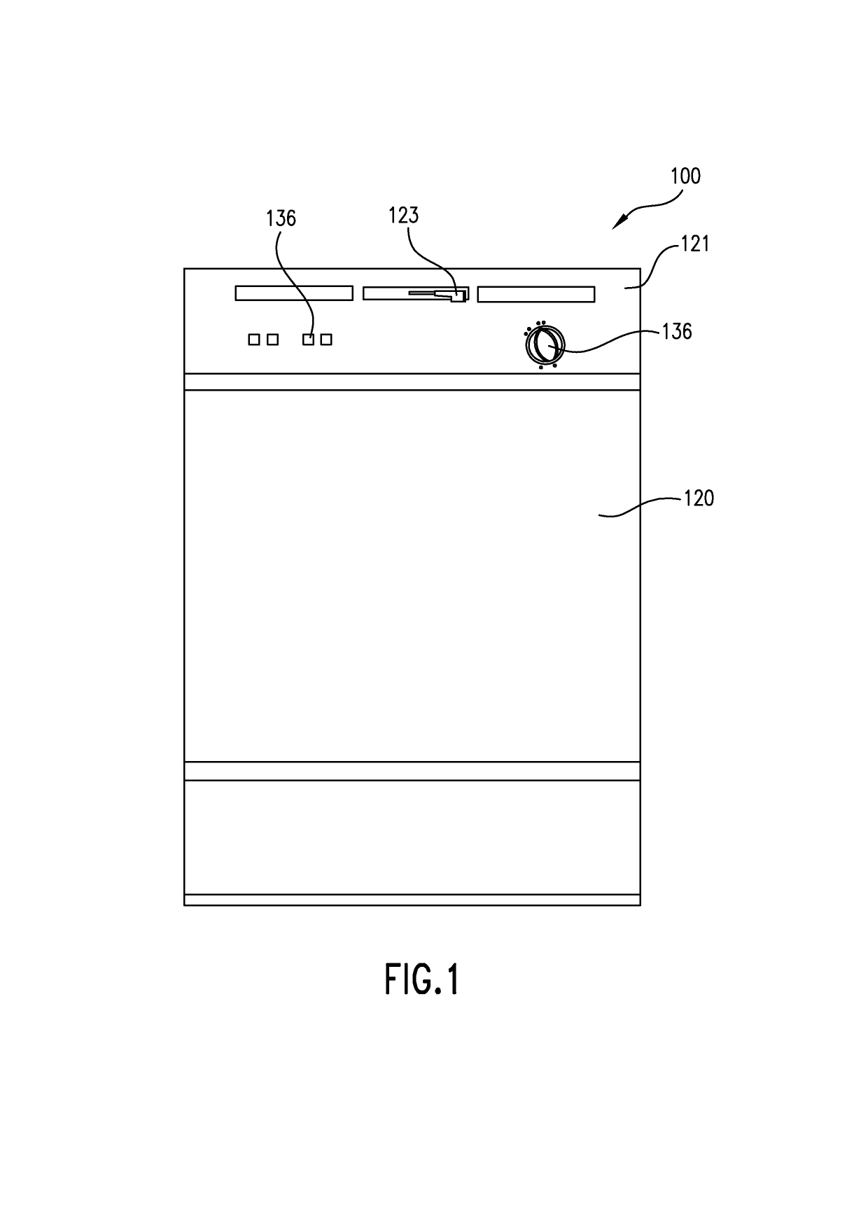

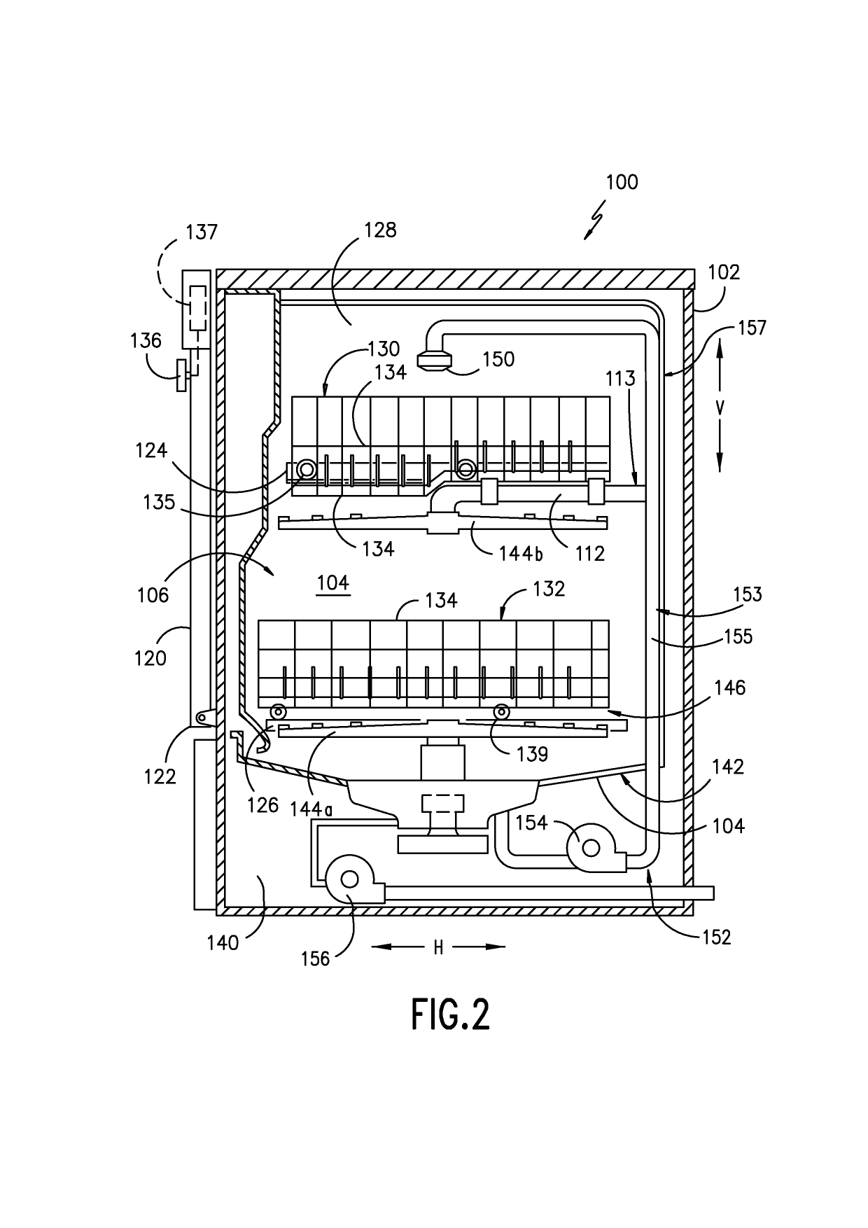

FIGS. 1 and 2 depict an exemplary domestic dishwasher 100 that may be configured in accordance with aspects of the present disclosure. For the particular embodiment of FIG. 1, the dishwasher 100 includes a cabinet 102 having a tub 104 that together define a wash chamber 106. The wash chamber 106 includes a front opening (not shown) and a door 120 hinged at its bottom 122 for movement between a normally closed vertical position (shown in FIGS. 1 and 2), wherein the wash chamber 106 is sealed shut for washing operation, and a horizontal open position for loading and unloading of articles from the dishwasher. Latch 123 is used to lock and unlock door 120 for access to chamber 106.

Upper and lower guide rails 124, 126 are mounted on tub side walls 128 and accommodate roller-equipped rack assemblies 130 and 132. Each of the rack assemblies 130, 132 is fabricated into lattice structures including a plurality of elongated members 134 (for clarity of illustration, not all elongated members making up assemblies 130 and 132 are shown in FIG. 2). Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106. This is facilitated by rollers 135 and 139, for example, mounted onto racks 130 and 132, respectively. A silverware basket (not shown) may be removably attached to rack assembly 132 for placement of silverware, utensils, and the like, that are otherwise too small to be accommodated by the racks 130, 132.

Upper rack assembly 130 is movable between a lower level and upper level along vertical direction V. As such, a user can adjust the vertical level of upper rack assembly 130 to accommodate larger utensils either in rack 130 or below in rack 132. A variety of mechanisms can be provided to allow for such adjustment of the rack assembly between levels as will be understood by one of skill in the art such that further description thereof is unnecessary.

The dishwasher 100 further includes a lower spray-arm assembly 144a that is rotatably mounted within a lower region 146 of the wash chamber 106 and above a tub sump portion 142 so as to rotate in relatively close proximity to rack assembly 132. A mid-level spray-arm assembly 144b is located in an upper region of the wash chamber 106 and is attached to, connected with, or integrated with upper rack 130. As upper rack 130 is slid in and out of wash chamber 106, mid-level spray arm assembly 144b moves with the rack 130 along with conduit 112 that provides wash or rinse fluids to assembly 144b from fluid supply 153. Conduit 112 includes a connecting end 113 that is oriented towards the rear wall of wash chamber 106. Additionally, an upper spray assembly 150 may be located above the upper rack 130.

The lower and mid-level spray-arm assemblies 144a, 144b and the upper spray assembly 150 are fed by a fluid circulation system 152 that provides for circulating dishwasher fluids (e.g., water, water and detergent) within chamber 106. The fluid circulation assembly 152 includes two pumps 154 and 156 located in a machinery compartment 140 below the bottom sump portion 142 of the tub 104, as generally recognized in the art. Pump 154 may be a variable speed pump that can be driven at a plurality of speeds. When pump 154 is energized, water may be circulated throughout the washing chamber 106. Pump 156 may be a drain pump that when energized, discharges water and soil from the washing chamber 106.

Pump 154 is connected to a fluid supply 153 that, for this embodiment, is constructed as vertically oriented conduit 155 that extends along the rear wall 157 of chamber 106. Each spray-arm assembly 144a, 144b includes an arrangement of discharge ports or orifices for directing washing liquid onto dishes or other articles located in rack assemblies 130 and 132. The arrangement of the discharge ports in spray-arm assemblies 144a, 144b provides a rotational force by virtue of washing fluid flowing through the discharge ports. For example, the resultant rotation of the lower spray-arm assembly 144a provides coverage of dishes and other dishwasher contents with a washing spray.

Operation of the dishwasher 100 is regulated by a controller 137 which is operatively coupled to a user interface panel 121 having an input 136 for user manipulation to select dishwasher machine cycles and features. In response to user manipulation of the user interface input 136, the controller 137 operates the various components of the dish washer 100 and executes selected machine cycles and features. The controller may include a memory and microprocessor, CPU or the like, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel area of door 120 as shown. In such an embodiment, input/output (“I/O”) signals may be routed between the control system and various operational components of dishwasher 100 along wiring harnesses that may be routed through the bottom 122 of door 120. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

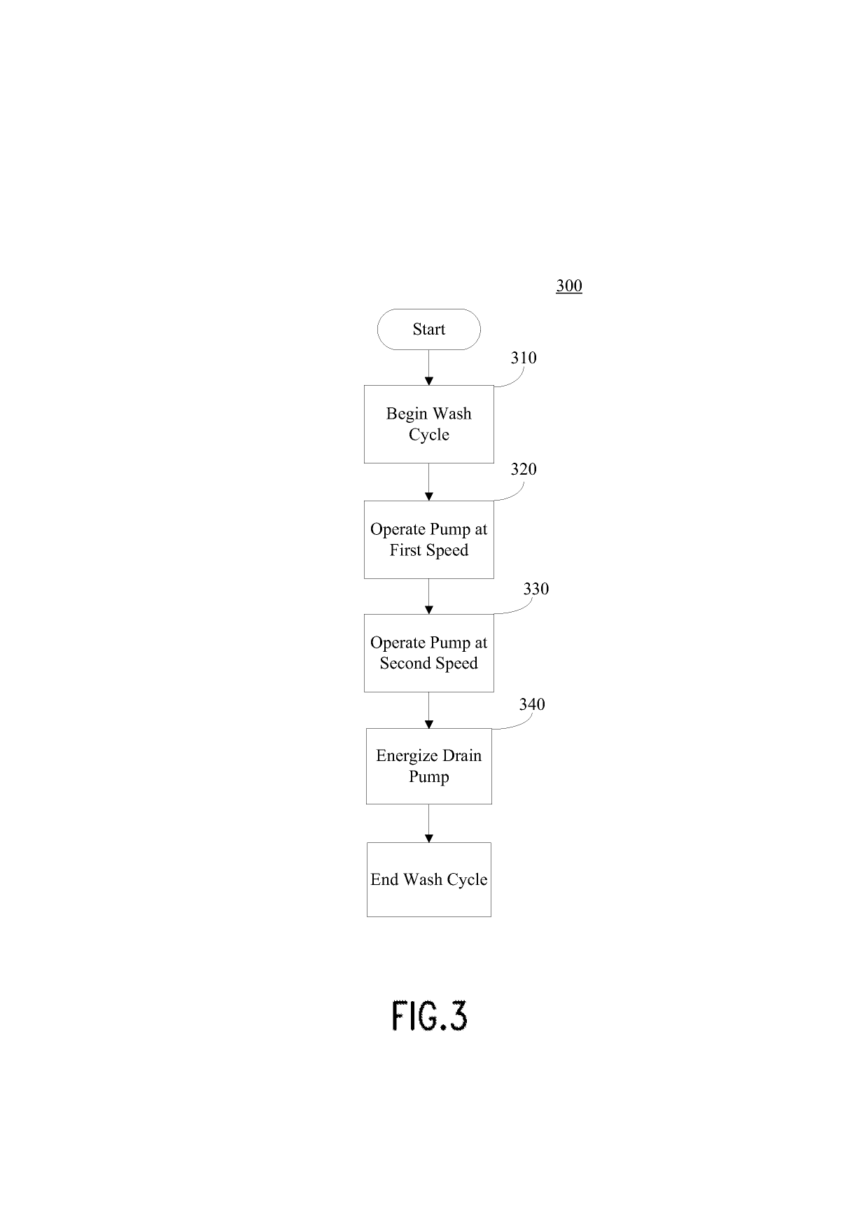

FIG. 3 provides a flow chart of exemplary method steps for removing soil from within a dishwasher. The method 300 may be implemented by the controller 137. In this exemplary embodiment, the method 300 includes the following steps. Beginning at 310, a cycle that includes a circulation of water, for example, a washing cycle, is initiated. A washing cycle may include heating water within the lower portion of tub 104, introducing detergent or other means of cleaning within wash chamber 106 and circulating water through the wash chamber 106. The circulation of water within the chamber 106 may be performed by the fluid circulation assembly 152. More specifically, the circulation of water may be performed by a variable speed pump 154 in the fluid circulation assembly 152.

In step 320, the variable speed pump 154 may be driven at a first speed (S₁) to circulate the water within the washing chamber 106. Step 320 may be performed for a first time period (T₁) which may be a predetermined time period or a variable time period. After the pump is driven at a first speed, the speed may be reduced to a second speed (S₂) in step 330 for a second time period (T₂). The pump may be operating at a speed less than the first speed but greater than zero in step 330 (S₁>S₂>0 rpm). For example, the pump may be driven at a speed of about 200 rpms. Step 330 may immediately follow step 320 with no pause or delay between the change in pump speeds. During step 330, fluid may be pumped to any or all of the spray arm assemblies in the dishwasher during the circulation of fluid at the second speed. For example, fluid may be pumped through only the lower spray-arm assembly 144a, only the mid-level assembly 144b, only the upper spray assembly 150 or any combination of two or more. Alternatively, the pump may run at a speed greater than zero, but may not circulate water within the wash chamber 106. Any soil in the wash tub may accumulate in the lower sump portion of the tub 142 during step 320 and/or step 330. The time duration of step 330 may be greater than or less than step 320 (T₂<T₁ or T₂>T₁). For example, the step of the operating the pump at a first speed could be performed for a predetermined time and then the pump could be operated at a second speed for about 15 seconds.

After the pump is driven at a second speed, the drain pump 156 is energized to remove any soil that has accumulated in the lower sump portion of the tub 142. This step may only be performed a single time during a wash cycle. Alternatively, step 340 may be performed a plurality of times. After the pump is energized and the soil is removed, the wash cycle may conclude and any subsequent cycles may be performed.

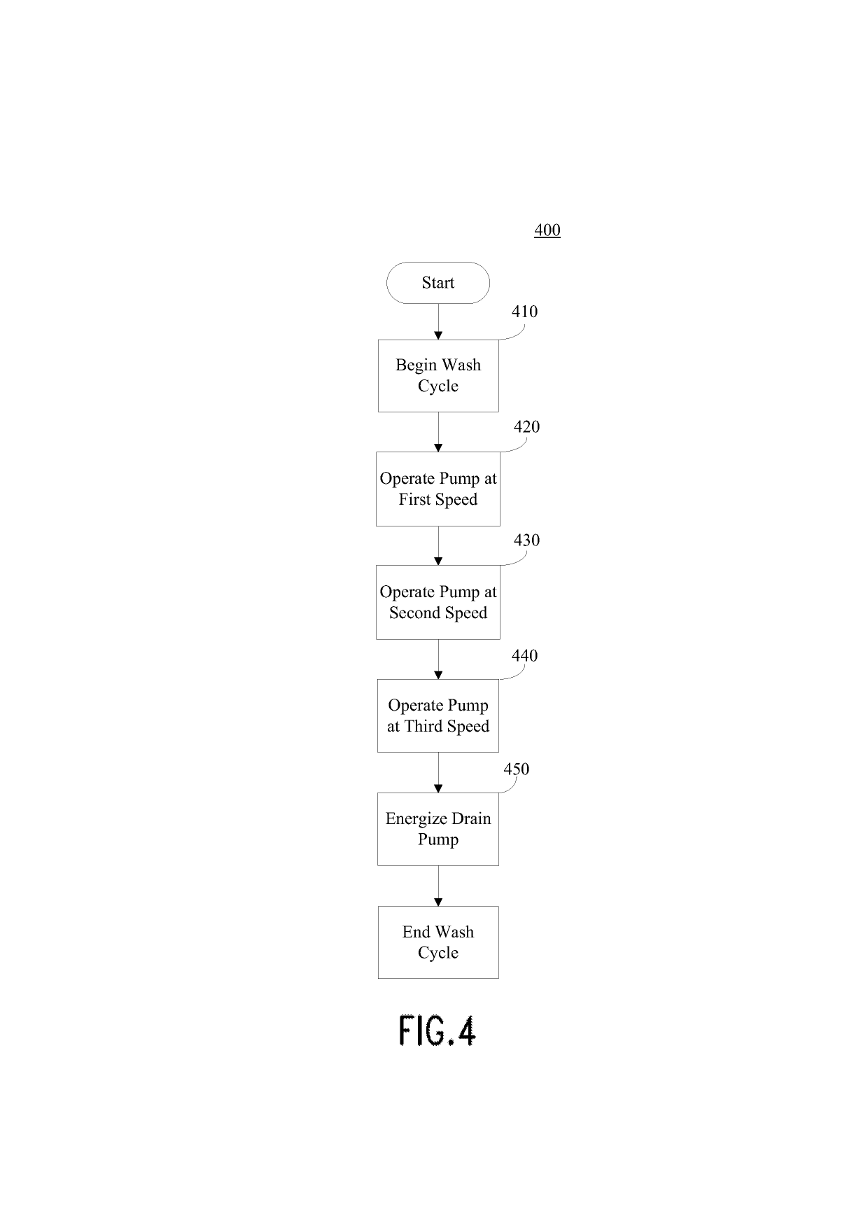

FIG. 4 provides another flow chart of alternative exemplary method steps for removing soil from within a dishwasher. The method 400 may be implemented by the controller 137. In this exemplary embodiment, the method 400 includes the following steps. Beginning at 410, a cycle that includes a circulation of water, for example, a washing cycle, may be initiated. In step 420, the variable speed pump 154 may be driven at a first speed to circulate water (S₁). Following step 420, the variable speed pump 154 may be driven at a second speed (S₂) less than the first speed but greater than zero (S₁>S₂>0 rpm). In step 440, pump 154 may be operated at a third speed (S₃). The third speed may be greater than or less than the first or second speeds (S₃>S₁ or S₃>S₂ or S₃<S₁ or S₃<S₂). In addition, the third speed may also be zero (S₃=0 rpms) or a holding step that may allow soil to further settle in the sump portion 142 of tub 104. After step 440, the drain pump may be energized in step 450 as previously discussed and the washing cycle ends.

It should be appreciated that the invention is not limited to any particular style, model, or other configuration of dishwasher, and that the embodiment depicted in FIGS. 1 and 2 is for illustrative purposes only. Other configurations including a fluid circulation assembly and pump may be used.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance, comprising:
a tub that defines a chamber for receipt of articles for cleaning;
a fluid circulation assembly that circulates water in said tub;
a drain pump that removes soil from said tub; and
a controller in communication with said fluid circulation assembly and said drain pump, wherein said controller:
operates said fluid circulation assembly at a first speed and a second speed during a wash cycle, wherein the second speed is slower than the first speed and greater than zero, and
activates said pump to remove soil from said tub after said fluid circulation assembly is driven at the second speed.

2. The dishwasher appliance, as in claim 1, wherein said fluid circulation assembly includes a variable speed pump that is driven at the first and second speed.

3. The dishwasher appliance, as in claim 1, wherein a first time interval (T₁) for controlling said fluid circulation assembly at the first speed is different from a second time period (T₂) for controlling said fluid circulation assembly at the second speed.

4. The dishwasher appliance, as in claim 3, wherein the first time interval (T₁) is greater than the second time interval (T₂).

5. The dishwasher appliance, as in claim 1, wherein said fluid circulation assembly is driven at the second speed until soil in the circulated water settles near said pump.

6. The dishwasher appliance, as in claim 1, wherein said controller controls said drain pump a single time during an operation.

7. The dishwasher appliance, as in claim 1, wherein said controller controls said fluid circulation assembly at the second speed for a predetermined time period immediately before controlling said drain pump to remove soil from the tub.

8. The dishwasher appliance, as in claim 1, wherein said controller controls said fluid circulation assembly at a third speed different from the first speed and the second speed.

9. A method for removing soil from within a dishwasher, the method comprising the steps of:
driving a fluid circulation assembly at a first speed to circulate water in a tub of the dishwasher during a wash cycle;
driving the fluid circulation assembly at a second speed during the wash cycle, wherein the second speed is slower than the first speed and greater than zero; and
removing soil from the tub after driving the fluid circulation assembly at the second speed by activating a drain pump.

10. The method of claim 9, wherein the fluid circulation assembly includes a variable speed pump that is driven at the first and second speed.

11. The method of claim 9, wherein the step of driving the fluid circulation assembly at the first speed is performed for a first time period (T₁) and the step of controlling the fluid circulation assembly at the second speed for a second time period (T₂), different from the first time period.

12. The method of claim 11, wherein the first time period (T₁) is greater than the second time period (T₂).

13. The method of claim 9, wherein the second speed has a predetermined duration.

14. The method of claim 9, wherein the step of driving the fluid circulation assembly at the second speed during the wash cycle is performed until soils in the circulated water settle near the pump.

15. The method of claim 9, wherein the step of controlling the pump to remove soil from the tub is performed a single time during an operation of the dishwasher.

16. The method of claim 9, wherein the step of controlling the fluid circulation assembly at the second speed is performed for a predetermined time period immediately before controlling the pump to remove soil from the tub.
